(19) United States
(12) Patent Application Publication
(10) Pub. No.: US 2006/0136077 A1
(43) Pub. Date: Jun. 22, 2006

(54) Data setting apparatus and data setting method

(75) Inventor: Motoichi Kuwatani, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/286,672

(22) Filed: Nov. 23, 2005

(30) Foreign Application Priority Data
Nov. 26, 2004 (JP) 2004-341609

(51) Int. Cl. G05B 15/00

(52) U.S. Cl. 700/83; 726/16

(57) ABSTRACT

A data setting apparatus has an accepting section, a deciding section, and a data setting section. The accepting section accepts an input of data to be set into a field equipment and an input of a key correlated with the field equipment. The deciding section decides whether or not the key accepted by the accepting section is correct. The data setting section sets the data accepted by the accepting section into the field equipment if the deciding section decides that the key accepted by the accepting section is correct.

### CROSS-REFERENCE TO RELATED APPLICATIONS

This application is based upon and claims the benefit of priority from the prior Japanese Patent Applications No. 2004-341609, filed on Nov. 26, 2004, the entire contents of which are incorporated herein by reference.

### BACKGROUND OF THE INVENTION

1. Field of the Invention

The present invention relates to a data setting apparatus and a data setting method for setting data into field equipments arranged in a plant and, more particularly, a data setting apparatus and a data setting method capable of employing other input information when the data is set.

2. Description of the Related Art

The plant control system capable of monitoring the field equipments arranged in respective portions of the plant by the common terminal unit has been known. The data can be set into the field equipments connected to such system, by operating the terminal unit of the plant control system. However, the access to the data must be limited from the perspective of security because control. of the field equipments is carried out based on the set data. Therefore, in the existing circumstances, the security is weighted by the constraint level every data as the set object, and then the authority given to the operator is compared with the constraint level to decide whether or not the access to the data is allowed.

In JP-A-2004-46585, it is set forth that, in the distributed control apparatus for controlling the field equipments, the operable range is limited based on the user's authority that has been registered on a security table.

JP-A-2004-46585 is referred to as a related art.

However, such access control method is based upon the decision of the writing authority given to each operator, but the security peculiar to the field equipments is not considered at all. In the related art, the mechanical locking mechanism is provided to the field equipment and then the operator can set the data by unlocking the mechanism by using the key, nevertheless the similar mechanism is not provided to the existing plant control system. Also, in the plant control system in the related art, such a problem exists that the information processing capability of the field equipment whose functions are enhanced cannot be utilized effectively.

### SUMMARY OF THE INVENTION

An object of the present invention is to provide a data setting apparatus and a data setting method capable of utilizing information except data to be set into a field. equipment when the data is set into the field equipment.

The invention provides a data setting apparatus for setting data into field equipments, having: an accepting section which accepts an input of data to be set into a field equipment and an input of a key correlated with the field equipment; a deciding section which decides whether or not the key accepted by the accepting section is correct; and a data setting section which sets the data accepted by the accepting section into the field equipment if the deciding section decides that the key accepted by the accepting section is correct.

According to the data setting apparatus, the input of the key correlated with the field equipment is accepted, and also the data is set into the field equipment if it is decided that the input key is correct. Therefore, the access to data in each field equipment can be limited appropriately on a field-equipment basis. As the key, for example, the different password can be set every field equipment.

In the data setting apparatus, the accepting section includes a displaying section which displays an input screen of the data and the key, and the displaying section displays to inform the data accepted by the accepting section on the input screen when the key is input through the accepting section.

In this case, when the input of the key is accepted, the input data is informed to be displayed on the input screen. Therefore, a person who inputs the key can easily recognize which data is correlated with the key, as a result, the operability can be improved. The displaying method of informing the input data can be selected appropriately. For example, the displayed portion of the input data can be displayed to blink or displayed in particular display color.

The invention also provides a data setting apparatus for setting data into field equipments, having: an accepting section which accepts an input of data to be set into a field equipment and an input of information correlated with the input of the data; a data setting section which sets the data accepted by the accepting section into the field equipment; and an information processing section which correlates the information accepted by the accepting section with the input of the data.

According to the data setting apparatus, the input of the information correlated with the input of the data is accepted, and also the input information is correlated with the input of data. Therefore, the information correlated with the input of the data can be utilized effectively. The information correlated with the input of the data, for example, may be information used to specify the person who inputs the data. Also, the input of the key correlated with the field equipment may be accepted.

In the data setting apparatus, the accepting section includes a displaying section which displays an input screen of the data and the information, and the displaying section displays to inform the data accepted by the accepting section on the input screen when the information is input through the accepting section.

In this case, when the input of the key is accepted, the input data is informed to be displayed on the input screen. Therefore, a person who inputs the information can easily recognize which data is correlated with the input of the information, as a result, the operability can be improved. The displaying method of informing the input data can be selected appropriately. For example, the displayed portion of the input data can be displayed to blink or displayed in particular display color.

In the data setting apparatus, the information is information correlated with an input person of the data. The information, for example, may be a password allocated to a person who inputs the data.

In the data setting apparatus, the information is information correlated with a setting of the data. The information, for example, may be a reason for change of data.

In the data setting apparatus, the information processing section stores the input information to correlate with the input of the data.

In this case, for example, the input person of the data and the reason for change of data can be recorded as an operation history.

The invention also provides a data setting method of setting data into field equipments, including steps of: accepting an input of data to be set into a field equipment and an input of a key correlated with the field equipment; deciding whether or not the input key is correct; and setting the input data into the field equipment if it is decided that the input key is correct.

According to the data setting method, the input of the key correlated with the field equipment is accepted, and also the data is set into the field equipment if it is decided that the input key is correct. Therefore, the access to data in each field equipment can be limited appropriately on a field-equipment basis. As the key, for example, the different password can be set every field equipment.

The data setting method further includes the steps of: displaying an input screen of the data and the key when the inputs of the data and the key are accepted, and displaying to inform the input data on the input screen when the input of the key is accepted.

In this case, when the input of the key is accepted, the input data is informed to be displayed on the input screen. Therefore, a person who inputs the key can easily recognize which data is correlated with the key, as a result, the operability can be improved. The displaying method of informing the, input data can be selected appropriately. For example, the displayed portion of the input data can be displayed to blink or displayed in particular display color.

The invention also provides a data setting method of setting data into field equipments, comprising the steps of: accepting an input of data to be set into a field equipment and an input of information correlated with the input of the data; setting the input data into the field equipment; and correlating the input information with the input of the data.

According to the data setting method, the input of the information correlated with the input of the data is accepted, and also the input information is correlated with the input of data. Therefore, the information correlated with the input of the data can be utilized effectively. The information correlated with the input of the data, for example, may be information used to specify the person who inputs the data. Also, the input of the key correlated with the field equipment may be accepted.

The data setting method further includes the steps of: displaying an input screen of the data and the information when the inputs of the data and the information are accepted, and displaying to inform the input data on the input screen when the input of the information is accepted.

In this case, when the input of the key is accepted, the input data is informed to be displayed on the input screen. Therefore, a person who inputs the information can easily recognize which data is correlated with the input of the information, as a result, the operability can be improved. The displaying method of informing the input data can be selected appropriately. For example, the displayed portion of the input data can be displayed to blink or displayed in particular display color.

In the data setting method, the information is information correlated with an input person of the data. The information, for example, may be a password allocated to a person who inputs the data.

In the data setting method, the information is information correlated with a setting of the data. The information, for example, may be a reason for change of data.

The data setting method further includes the steps of: storing the input information to correlate with the input of the data.

In this case, for example, the input person of the data and the reason for change of data can be recorded as an operation history.

According to the data setting apparatus and the data setting method, the input of the key correlated with the field equipment is accepted, and also the data is set into the field equipment if it is decided that the input key is correct. Therefore, the access to data in each field equipment can be appropriately limited on a field-equipment basis. Also, the input of the information correlated with the input of the data is accepted, and also the input information is correlated with the input of data. Therefore, the information correlated with the input of the data can be utilized effectively.

### BRIEF DESCRIPTION OF THE DRAWINGS

FIG. 1 is a block diagram showing a configuration of a plant control system to which a data setting apparatus of the present embodiment is applied;

FIG. 2 is a block diagram showing functions of the data setting apparatus of the present embodiment;

FIG. 3 is a flowchart showing procedures of a process executed in accessing the data that the field equipment holds;

FIG. 4 is a view showing a display screen of an instrument view; and

FIGS. 5A and 5B are views showing a table used to decide whether or not data writing can be allowed, wherein FIG. 5A is a view showing a table for comparing an operator's authority and a function constraint level, and FIG. 5B is a view showing a table for specifying the function constraint level, at which the data writing is allowed, every function block.

### DETAILED DESCRIPTION OF THE PREFERRED EMBODIMENTS

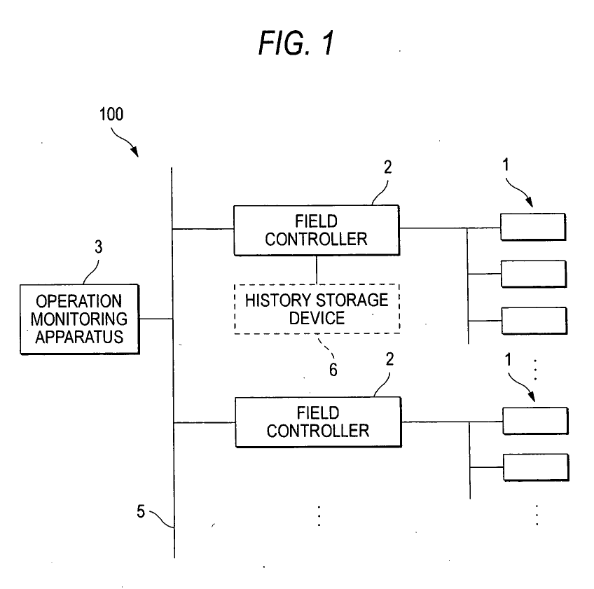

An embodiment of a data setting apparatus according to the present invention will be explained with reference to FIG. 1 to FIG. 5B hereinafter.

FIG. 1 is a block diagram showing a configuration of a plant control system to which a data setting apparatus of the present embodiment is applied.

As shown in FIG. 1, a plant control system 100 includes field controllers 2, 2, . . . for controlling field equipments 1, 1, . . . such as control valves, sensors, and the like arranged in the plant to distribute therein, and an operation monitoring apparatus 3 for monitoring integrally the field equipments 1, 1, . . . via the field controllers 2, 2, . . . arranged to distribute. As shown in FIG. 1, the operation monitoring apparatus 3 and the field controllers 2, 2, . . . are connected mutually via a communication bus 5.

The operation monitoring apparatus 3 executes a process control of the field equipments 1, 1, . . . via the field controllers 2, 2, . . . Also, the field equipment 1 has the data to specify its functions, and the operation monitoring apparatus 3 can access the data held by the field equipment 1 in response to.the operator's operation.

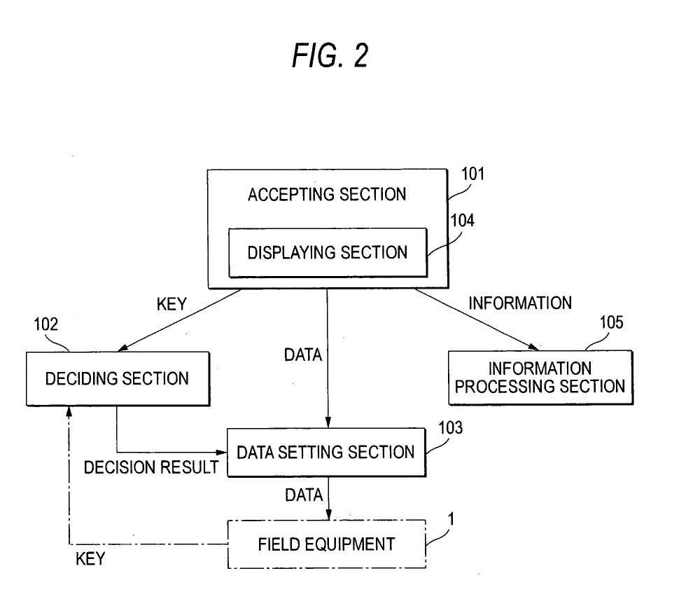

FIG. 2 is a block diagram showing functions of the data setting apparatus of the present embodiment.

In FIG. 2, an accepting section 101 accepts an input of the data to be set into the field equipment 1 and an input of the key provided to that field equipment 1. A deciding section 102 decides whether or not the key the input of which is accepted is correct. Provided that the deciding section 102 decided that the key whose input is accepted is correct, a data setting section 103 sets the data into that field equipment 1. The accepting section 101 has a displaying section 104 for displaying an input screen of the data and the key. In accepting the input of the key, the displaying section 104 executes a display to inform the input data on the input screen.

Also, the accepting section 101 accepts an input of the data to be set into the field equipment 1, and an input of information that is correlated with the input of that data. An information processing section 105 processes the information the input of which is accepted to correlate with the input of the data. In accepting the input of the information, the displaying section 104 executes a display to inform the input data on the input screen.

The accepting section 101, the deciding section 102, the data setting section 103, the displaying section 104, and the information processing section 105 are constructed as a function of the operation monitoring apparatus 3 respectively.

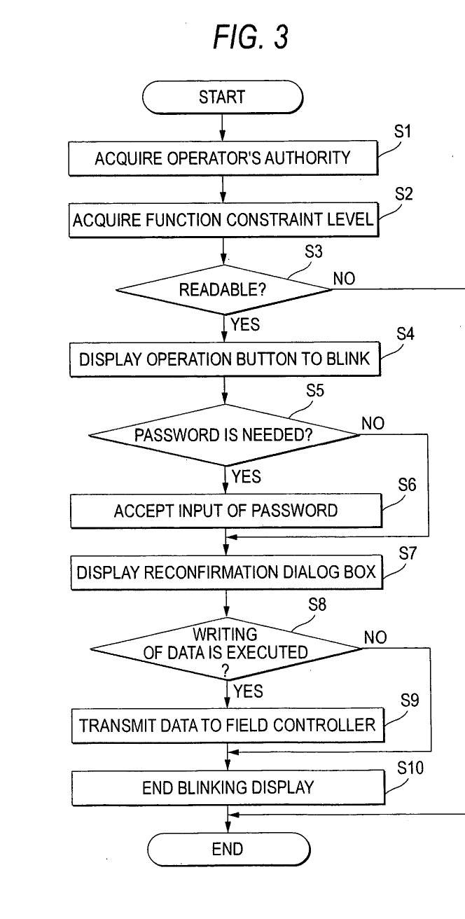

FIG. 3 is a flowchart showing procedures of a process executed in the plant control system 100 (FIG. 1) in accessing the data that the field equipment 1 holds. The process shown in FIG. 3 is executed under control of the operation monitoring apparatus 3 (FIG. 1).

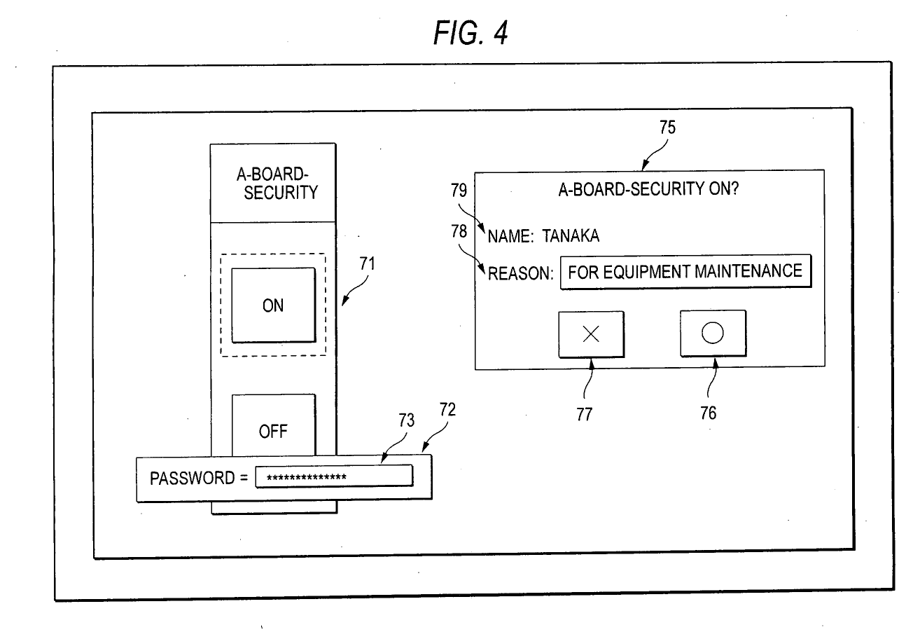

An instrument view used to input the data into the field equipment 1 is displayed on a display device (not shown) of the operation monitoring apparatus 3. FIG. 4 is a view showing a display screen of the instrument view. The instrument view is a user interface window that is prepared to the operation monitoring apparatus 3 and is used when the operator operates the field equipment 1 in the plant.

In the plant control system 100, in order to facilitate the access to the field equipment 1, the data such as input output values, etc. to the field equipment 1 are allocated in advance to the function blocks of the corresponding field controller 2. Therefore, the access to the field equipment 1 is executed via the function blocks of the field controller 2 expressed on the instrument view.

In the process shown in FIG. 3, an example in which ON/OFF (1 or 0) of one data is set into the functional block of the switch-type field equipment 1 is illustrated. In this example, the operator when clicks a button 71 (FIG. 4) on the instrument view can transmit the data allocated to the button 71 to the corresponding field controller 2. The process shown in FIG. 3 is started when the operator clicks the button 71.

In step S1 in FIG. 3, the operator acquires an operator's authority based on the operator's ID that is input previously. In the present embodiment, a function constraint level at which the data writing is allowed is set every function block. The operator compares the operator's authority with the function constraint level to decide whether or not the writing of data into the function block is allowed.

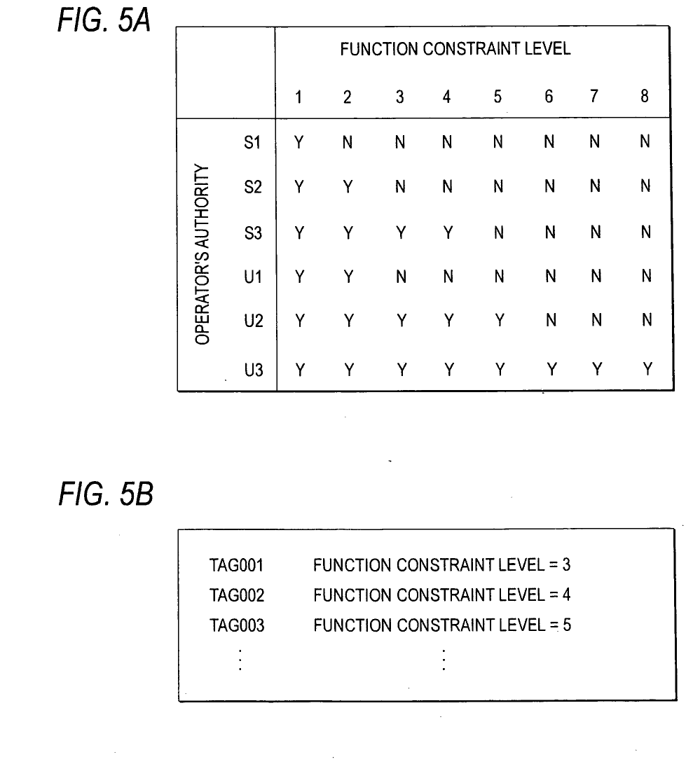

FIG. 5A is a view showing a table used to decide whether or not the writing of data into the function block is allowed, by comparing the operator's authority and the function constraint level. The function constraint level at which the writing of data is allowed is defined every operator's authority. FIG. 5B shows a table for specifying the function constraint level, at which the writing of data is allowed, every function block. These tables are stored in a memory device (not shown) of the operation monitoring apparatus 3, for example.

Then, in step S2, the operator acquires the function constraint level of the function block as the object of operation of the button 71 from the table in FIG. 5B. In FIG. 5B, “TAG001”, “TAG002”, etc. indicate the function block respectively. In this example, it is illustrated that the function constraint level of the function. block indicated by “TAG001” is “3”.

Then, in step S3, the table in FIG. 5A is looked up. Thus, it is decided. whether or not the writing of data is allowed, based on the operator's authority acquired in step S1 and the function constraint level of the function block acquired in step S2.

For example, in the case where the operator's authority is “S1” in FIG. 5A, the writing of data is allowed when the function-constraint level of the function block is “1” whereas the writing of data is rejected when the function constraint level is “2” or more. Also, in the case where the operator's authority is “S3”, the writing of data is allowed when the function constraint level of the function block is “4” or less whereas the writing of data is rejected when the function constraint level is “5” or more. Therefore, in the case of the writing of data into the function block indicated by “TAG001”, the writing of data is allowed when the operator's authority is “S3” whereas the writing of data is rejected when the operator's authority is “S1”.

If the decision in step S3 is YES, the process goes to step S4. If such decision is NO, the process is ended.

If it is decided that the writing of data is allowed, in step S4, a frame of the clicked button 71 is displayed in particular color and also a blinking display of the frame is started. According to such process, the operator can recognize easily the button as the object of operation (the button 71 in FIG. 4). This process corresponds to the function of the displaying. section 104 (FIG. 2).

Then, in step S5, it is decided whether or not the field equipment 1 as the object of the data writing corresponds to the equipment that requests the input of a password. It is indicated previously in the data that are held by the corresponding field controller 2 whether or not each field equipment 1 requests the input of the password. In step S5, the decision is made based on this data. If the decision in step S5 is YES, the process goes to step S6. If such decision is NO, the process skips to step S7.

In step S6, a password input dialog box 72 (FIG. 4) used to input the password is displayed on the display device of the operation monitoring apparatus 3 to accept the input of the password. The process in step S6 corresponds to the function of the accepting section 101 (FIG. 2)

When the operator inputs the password, a character string is displayed in a display area 73 in the password input dialog box 72 as a row of “*s” to prevent the leakage of the password. At this time, because a blinking display of the frame of the button 71 is still continued, the operator can recognize easily that the password is being input in response to the operation of the button.

In step S6, the password the input of which is accepted functions as the key that is correlated with the field equipment 1 as the object of the data writing. The different character strings are correlated with individual field equipments 1 as the password every operator. The passwords that are correlated with the field equipments 1 are stored in respective field equipments 1 as a table in which correspondences between the operators and the passwords are defined respectively.

Then, in step S7, a reconfirmation dialog box 75 (FIG. 4) is displayed on the display device of the operation monitoring apparatus 3 to accept the input of the final operator's decision that indicates whether or not the writing of data should be executed. The operator when executes the writing of data clicks an area 76 of the reconfirmation dialog box 75, while the operator when cancels the writing of data clicks an area 77 of the reconfirmation dialog box 75. In step S7, the operation applied to the area 76 or the area 77 is accepted.

Also, an area 78 used to input the reason for change of data is provided to the reconfirmation dialog box 75. The operator inputs the reason for change of data into the area 78. In step S7, the input reason for change of data is accepted. This process corresponds to the function of the accepting section 101 (FIG. 2). At this time, because the blinking display of the frame of the button 71 is still continued, the operator can recognize easily that the operation of the button 71 is being reconfirmed.

The operator's name is displayed in an area 79 of the reconfirmation dialog box 75. This name is acquired based on the operator's ID that is previously input.

In step S7, information showing the area 76 or the area 77 that is clicked by the operator and the input reason for change are acquired.

Then, in step S8, the input password input in step S6 is compared with the operator's password, which is correlated with the field equipment 1 as the object of data setting, to decide whether or not the input password is correct. As described above, the password correlated with the field equipment 1 is stored in the field equipment 1 as the table that defines the correspondences between the operators and respective passwords. In step S8 (FIG. 2), it is decided by looking up this table whether or not the input password is correct. This process corresponds to the function of the deciding section (FIG. 2).

If this decision is NO, the process skips to step S10. If this decision is YES, it is decided in step S8 whether or not the writing of data should be executed, based on the reconfirmation information acquired in step S7. If this decision is YES, the process goes to step S9. If this decision is NO, the process skips to step S10.

In step S9, the operator's ID, the input data value (value allocated to the button 71), the field equipment 1 as the object of data setting (function block), and the input reason for change of data are transmitted to the field controller 2 (FIG. 1) that corresponds to the field equipment 1 as the object of data setting. Then, the field controller 2 holds a communication with the corresponding field equipment 1 to set the data into the field equipment 1. This process corresponds to the function of the data setting section 103 (FIG. 2).

Then, in step S10, the blinking display of the frame of the button 71 is ended. Then, the process is ended.

As explained above, in the present embodiment, the password as well as the data set by the button operation can be input, and then the access to the data is limited by comparing the input password with the password that is correlated in advance with the field equipment 1. Therefore, like the case where the mechanical locking mechanism is provided to the field equipment 1, the security management can be attained on a field-equipment basis. If the access limitation cannot be realized on a field-equipment basis, only the access limitation can be applied based on the operator's authority, as described above. According to the method executed based on the operator's authority, the operator's authority of the access is decided. Thus, the authority of the access is decided one-dimensionally based on the function constraint level irrespective of the field equipment 1. Also, the function constraint level gives a rough classification (for example, 8 levels in the present embodiment), so that the security management cannot be attained in fact on a field-equipment basis.

However, for example, in the case where a scale of the plant is increased to some extent, it is not preferable from the perspective of security management of each field equipment 1 that all the operators are allowed uniformly to access the data of all the field equipments 1 based on the operator's authority. In the present embodiment, the security management of individual field equipments 1 can be carried out like the mechanical locking mechanism, while permitting the operation monitoring apparatus 3 to access the data.

Also, in the present embodiment, the reason for change of data in addition to the data being set by the button operation can be input, and this reason is transmitted to the field controller (step S9 in FIG. 3). Since additional information except the data being set in this manner are input, such input additional information can be utilized effectively.

For example, as shown in FIG. 1, a history storage device 6 may be provided to correspond to the field controller 2. Then, the reason for change of data may be stored in the corresponding history storage device 6 in such a manner that the reason is correlated with the operator's ID, the operator indicated by the input password, the value of the input data, the field equipment (function block) as the object of data setting, and the like. The input data and information may be stored temporarily in the operation monitoring apparatus 3. In this case, the data and information are deleted automatically in seriatim from earlier information, and thus the data and information cannot be saved for a long term. For this reason, since such information are accumulated in the history storage device 6, the record of the access to the data of the field equipment 1 can be utilized as an audit trail, and thus the effective security management of the field equipment 1 can be achieved.

For example, in the food/medicine plant, since the change of data seriously affects a safety of the final product, it has an important meaning to manage the access history to the data of the field equipment 1. For example, the history can be managed by accumulating the information about the change of data in the field controller 2 as batch data after the batch of one product is completed. Such process corresponds to the function of the information processing section 105 (FIG. 2).

Also, as the additional information except the set data, a color code value of the lamp corresponding to the operator, which is indicated by the input password, can be transmitted to the field controller 2 or the field equipment 1. In this case, the operator who is accessing to the data of the field equipment 1 can be displayed on an instrument panel by lighting the lamp in color indicated by the color code value. Such process corresponds to the function of the information processing section 105 (FIG. 2).

Application fields of the present invention are not limited to the above embodiment. The present invention can be applied widely in the situation that the field equipments into which the data can be set are arranged.

What is claimed is:

1. A data setting apparatus for setting data into field equipments, comprising:
an accepting section which accepts an input of data to be set into a field equipment and an input of a key correlated with the field equipment;
a deciding section which decides whether or not the key accepted by the accepting section is correct; and
a data setting section which sets the data accepted by the accepting section into the field equipment if the deciding section decides that the key accepted by the accepting section is correct.

2. The data setting apparatus according to claim 1,
wherein the accepting section includes a displaying section which displays an input screen of the data and the key, and
the displaying section displays to inform the data accepted by the accepting section on the input screen when the key is input through the accepting section.

3. A data setting apparatus for setting data into field equipments, comprising:
an accepting section which accepts an input of data to be set into a field equipment and an input of information correlated with the input of the data;
a data setting section which sets the data accepted by the accepting section into the field equipment; and
an information processing section which correlates the information accepted by the accepting section with the input of the data.

4. The data setting apparatus according to claim 3,
wherein the accepting section includes a displaying section which displays an input screen of the data and the information, and
the displaying section displays to inform the data accepted by the accepting section on the input screen when the information is input through the accepting section.

5. The data setting apparatus according to claim 4,
wherein the information is information correlated with an input person of the data.

6. The data setting apparatus according to claim 4,
wherein the information is information correlated with a setting of the data.

7. The data setting apparatus according to claim 3,
wherein the information processing section stores the input information to correlate with the input of the data.

8. A data setting method of setting data into field equipments, comprising the steps of:
accepting an input of data to be set into a field equipment and an input of a key correlated with the field equipment;
deciding whether or not the input key is correct; and
setting the input data into the field equipment if it is decided that the input key is correct.

9. The data setting method according to claim 8, further comprising the steps of:
displaying an input screen of the data and the key when the inputs of the data and the key are accepted, and
displaying to inform the input data on the input screen when the input of the key is accepted.

10. A data setting method of setting data into field equipments, comprising the steps of:
accepting an input of data to be set into a field equipment and an input of information correlated with the input of the data;
setting the input data into the field equipment; and
correlating the input information with the input of the data.

11. The data setting method according to claim 10, further comprising the steps of:
displaying an input screen of the data and the information when the inputs of the data and the information are accepted, and
displaying to inform the input data on the input screen when the input of the information is accepted.

12. The data setting method according to claim 11,
wherein the information is information correlated with an input person of the data.

13. The data setting method according to claim 11,
wherein the information is information correlated with a setting of the data.

14. The data setting method according to claim 10, further comprising the steps of:
storing the input information to correlate with the input of the data.
